(19) United States
(12) Patent Application Publication
(10) Pub. No.: US 2023/0095172 A1
(43) Pub. Date: Mar. 30, 2023

(54) FOLDING BARBECUE GRILL

(71) Applicant: Xiu Cao, Anqing (CN)

(72) Inventor: Xiu Cao, Anqing (CN)

(21) Appl. No.: 17/991,862

(22) Filed: Nov. 22, 2022

(51) Int. Cl. F24B 1/20; A47J 37/07

(52) U.S. Cl. CPC F24B 1/205; A47J 37/0763; A47J 2037/0777

(57) ABSTRACT

The present invention discloses a folding barbecue grill, comprising a forked bracket and a charcoal receiving assembly. The charcoal receiving assembly is arranged on the forked bracket. The barbecue grill in the present invention is simple in structure, convenient in folding, adjustable in height and strong in stability.

### TECHNICAL FIELD

The present invention relates to the technical field of outdoor articles and cooking articles, more particularly to a folding barbecue grill.

### BACKGROUND

A barbecue grill is a common camping barbecue appliance. Charcoal trays are arranged on a grill body; firewood is placed on the charcoal trays for combustion or lighting; baking trays, baking nets and the like are placed on the top of the grill body; and food to be cooked is placed on the baking trays and the baking nets for barbecue and cooking. In recent years, with the improvement of living standards of people, people have frequently begun to go camping and hiking in the suburbs. The barbecue grill is a necessary appliance for camping barbecue. For portability, a folding barbecue grill is loved by many campers.

However, there are some problems with some folding barbecue grills on the market at present. For example, the folding and unfolding process is relatively complicated and inconvenient to operate; the overall height of the barbecue grill cannot be adjusted; and the stability of the grill body is not high enough to bear heavy firewood or barbecue charcoal.

Thus, the problem to be solved by those skilled in the art is to research a folding barbecue grill with folding convenience, adjustable height and strong stability.

### SUMMARY

In view of this, the present invention provides a folding barbecue grill which is convenient in folding, adjustable in height and strong in stability.

To achieve the above purpose, the present invention adopts the following technical solution:

A folding barbecue grill comprises:

a forked bracket; and

a charcoal receiving assembly, wherein the charcoal receiving assembly is arranged on the forked bracket.

Preferably, the charcoal receiving assembly is a charcoal tray or a charcoal net or a fireproof fiber cloth.

Preferably, the charcoal tray is selected as the charcoal receiving assembly, and the charcoal tray is detachably arranged on the top of the forked bracket.

Preferably, the charcoal tray comprises first charcoal trays and second charcoal trays, and the first charcoal trays and the second charcoal trays are respectively detachably connected to both sides of the top of the forked bracket; and the bottoms of the first charcoal trays and the bottoms of the second charcoal trays are detachably connected.

Preferably, the tops of the first charcoal trays and the tops of the second charcoal trays are provided with hooks; the bottoms of the first charcoal trays are uniformly provided with a plurality of inserting sheets; the bottoms of the second charcoal trays are provided with inserting holes at positions corresponding to the inserting sheets; and the inserting sheets are correspondingly inserted into the inserting holes. The first charcoal trays and the second charcoal trays are arranged at the top of the forked bracket in a mode of hanging and buckling, to facilitate disassembling and assembling; and moreover, the first charcoal trays and the second charcoal trays are connected by inserting, which is more convenient for connection and more convenient for realization of folding storage for the barbecue grill.

Preferably, a plurality of first charcoal trays and a plurality of second charcoal trays are arranged; the plurality of first charcoal trays are successively connected; the plurality of second charcoal trays are successively connected; and the first charcoal tray located at the bottom is connected with the second charcoal tray located at the bottom. A plurality of first charcoal trays and a plurality of second charcoal trays can be assembled; the height of the charcoal trays can be adjusted by adjusting the quantity of the first charcoal trays and the second charcoal trays to adapt to the hanging height of food; and the burning area can be concentrated.

Preferably, the forked bracket comprises: left brackets, right brackets and a hinging shaft structure; the left brackets and the right brackets are crossed in X-shaped arrangement, and the hinging shaft structure is arranged at a hinging position between the left brackets and the right brackets; the surface of the hinging shaft structure is provided with two limiting jaws which are respectively placed below the left brackets and the right brackets, and abutted against the left brackets and the right brackets; two groups of left brackets and two groups of right brackets are arranged, and top rods are respectively arranged between the tops of the two left brackets and between the tops of the two right brackets; and bottom rods are respectively arranged between the bottoms of the two left brackets and between the bottoms of the two right brackets. The left brackets and the right brackets can be rotated to realize unfolding or folding of the barbecue grill to facilitate operation. The hinging shaft structure can limit a forking distance between the left brackets and the right brackets to prevent the forked bracket from collapsing.

Preferably, auxiliary bottom rods are respectively arranged between the bottoms of the two left brackets and between the bottoms of the two right brackets; the auxiliary bottom rods are located above the bottom rods; and an ash receiving plate is connected between the two auxiliary bottom rods. The ash receiving plate is located below the charcoal trays and used for receiving charcoal ash which falls on the charcoal trays.

Preferably, both sides of the first charcoal trays and the second charcoal trays are provided with baffle plates. The baffle plates can limit the charcoal on the charcoal trays, and can play the role of wind protection.

Preferably, transverse rods are respectively arranged between the tops of the two left brackets and between the tops of the two right brackets; the tops of the first charcoal trays and the tops of the second charcoal trays are respectively connected with the two transverse rods; the tops of the left brackets and the right brackets are provided with a barbecue net; and both sides of the barbecue net are detachably connected with two top rods respectively. The barbecue net can be used to grill food, and the barbecue net is convenient to be installed and disassembled.

Preferably, transverse rods are respectively arranged between the tops of the two left brackets and between the tops of the two right brackets; the tops of the first charcoal trays and the tops of the second charcoal trays are respectively connected with the two transverse rods; the surfaces of the two top rods are provided with positioning frame rods; the positioning frame rods are arranged on one side of the top rods away from the first charcoal trays or the second charcoal trays; one of the top rods is hinged with a grid frame; the grid frame is placed at the top of the positioning frame rods; the other top rod is hinged with a stowage plate; and the stowage plate is placed at the top of the positioning frame rods. The grid frame can be used for placing barbecue food to cool and drop oil, and the auxiliary stowage plate can be used for putting spices or food to be barbecued.

Preferably, the tops of the first charcoal trays and the tops of the second charcoal trays are respectively connected with the two top rods; auxiliary transverse rods are respectively arranged between the bottoms of the two left brackets and between the bottoms of the two right brackets; high and low double-rod frames are hinged at the auxiliary transverse rods; and the tops of the high and low double-rod frames extend upwards and are abutted against one side of the top rods close to the first charcoal trays or the second charcoal trays. The auxiliary transverse rods can connect the vertical high and low double-rod frames directly to the top rods, so that the connection mode of the high and low double-rod frames is more convenient.

Preferably, the tops of the first charcoal trays and the tops of the second charcoal trays are respectively connected with the two top rods; and the high and low double-rod frames are connected between the tops of the two left brackets and between the tops of the two right brackets. The high and low double-rod frames can be used for hanging type barbecue, so that the barbecue mode is more diverse.

Preferably, the forked bracket comprises: first bracket groups, second bracket groups and a hinging shaft structure; the first bracket groups and the second bracket groups are respectively formed by crossing and hinging the left brackets and the right brackets in X shape; the tops of the right brackets of the first bracket groups are hinged with the tops of the left brackets of the second bracket groups; the hinging shaft structure is arranged at a joint between the bottoms of the left brackets of the first bracket groups and the bottoms of the right brackets of the second bracket groups; the surface of the hinging shaft structure is provided with two limiting jaws which are respectively placed below the left brackets and the right brackets, and abutted against the left brackets and the right brackets; two first bracket groups and two second bracket groups are respectively arranged; top rods are respectively arranged between the tops of the left brackets of the two first bracket groups and between the tops of the right brackets of the two second bracket groups; and bottom rods are respectively arranged between the bottoms of the right brackets of the two first bracket groups and between the bottoms of the left brackets of the two second bracket groups. The connection mode of the first bracket groups and the second bracket groups makes the whole forked bracket more stable, which can adapt to larger operation demands and can erect and bear more auxiliary structures.

Preferably, auxiliary bottom rods are respectively arranged between the bottoms of the right brackets of the two first bracket groups and between the bottoms of the left brackets of the two second bracket groups; the auxiliary bottom rods are located above the bottom rods; and an ash receiving plate is connected between the two auxiliary bottom rods.

Preferably, both sides of the first charcoal trays and the second charcoal trays are provided with baffle plates.

Preferably, transverse rods are respectively arranged between the tops of the left brackets of the two first bracket groups and between the tops of the right brackets of the second bracket groups; the tops of the first charcoal trays and the tops of the second charcoal trays are respectively connected with the two transverse rods; the tops of the first bracket groups and the second bracket groups are provided with a barbecue net; and both sides of the barbecue net are detachably connected with two top rods respectively.

Preferably, transverse rods are respectively arranged between the tops of the left brackets of the two first bracket groups and between the tops of the right brackets of the second bracket groups; the tops of the first charcoal trays and the tops of the second charcoal trays are respectively buckled with the two transverse rods; the surfaces of the two top rods are provided with positioning frame rods; the positioning frame rods are arranged on one side of the top rods away from the first charcoal trays or the second charcoal trays; one of the top rods is hinged with a grid frame; the grid frame is placed at the top of the positioning frame rods; the other top rod is hinged with a stowage plate; and the stowage plate is placed at the top of the positioning frame rods.

Preferably, the tops of the first charcoal trays and the tops of the second charcoal trays are respectively connected with the two top rods; the tops of the left brackets of the first bracket groups and the tops of the right brackets of the two second bracket groups are provided with hollow vertical pipes; the tops of the top rods are provided with U-shaped extension frames; and two U-shaped ends of the extension frames are respectively inserted into the vertical pipes at both ends of the top rods. The inserting structures of the vertical pipes can add a layer of stowage rack for a barbecue oven, so that double-layer barbecue can be conducted.

Preferably, the tops of the first charcoal trays and the tops of the second charcoal trays are respectively connected with the two top rods; auxiliary transverse rods are respectively arranged between the bottoms of the right brackets of the two first bracket groups and between the bottoms of the left brackets of the two second bracket groups; high and low double-rod frames are hinged at the auxiliary transverse rods; and the tops of the high and low double-rod frames extend upwards and are abutted against one side of the top rods close to the first charcoal trays or the second charcoal trays.

It can be known form the above technical solution that compared with the prior art, the present invention provides a folding barbecue grill, and has beneficial effects:

(1) The barbecue grill in the present invention is easy to be tidied and folded. The left brackets and the right brackets are symmetrically folded or directly disassembled from the hinging structure; the charcoal trays can also be disassembled; and storage, packaging and transportation of the whole are very convenient.

(2) The first bracket groups and the second bracket groups are used to form a grill body structure in double X shape; the overall stability is good; the barbecue grill can adapt to the cooking demand of large barbecue area and heavy weight;

(3) Multi-layer or hanging barbecue can be conducted, so that the modes or types of grilling are increased.

### DESCRIPTION OF DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a structural schematic diagram of a barbecue grill in embodiment 2 provided by the present invention;

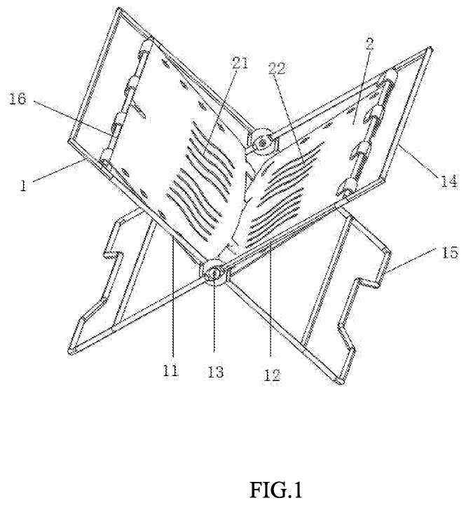

FIG. 2 is an explosive view of a barbecue grill provided with baffle plates in embodiment 2 provided by the present invention;

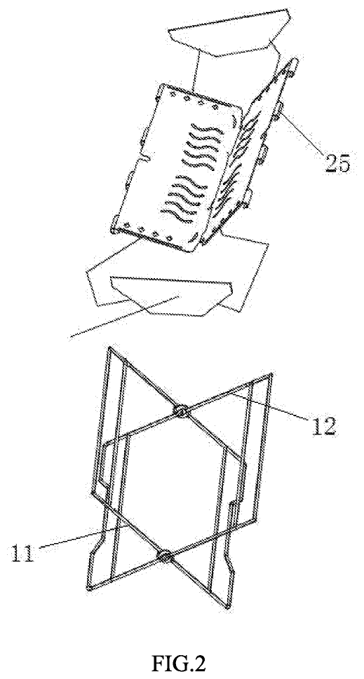

FIG. 3 is a structural schematic diagram of a charcoal tray provided by the present invention;

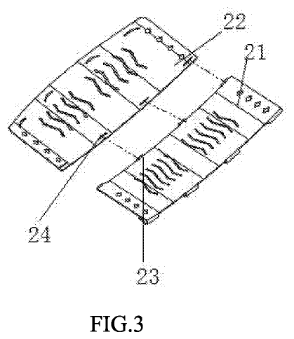

FIG. 4 is a structural schematic diagram of a barbecue grill in embodiment 3 provided by the present invention;

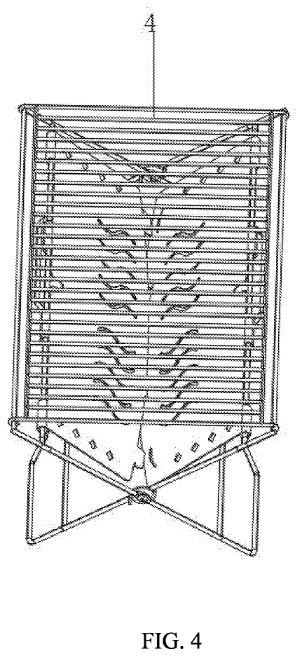

FIG. 5 is a structural schematic diagram of a barbecue grill in embodiment 4 provided by the present invention;

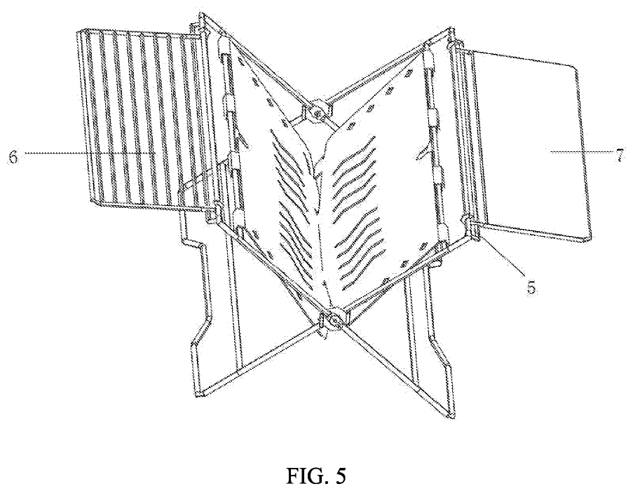

FIG. 6 is a structural schematic diagram of a barbecue grill in embodiment 5 provided by the present invention;

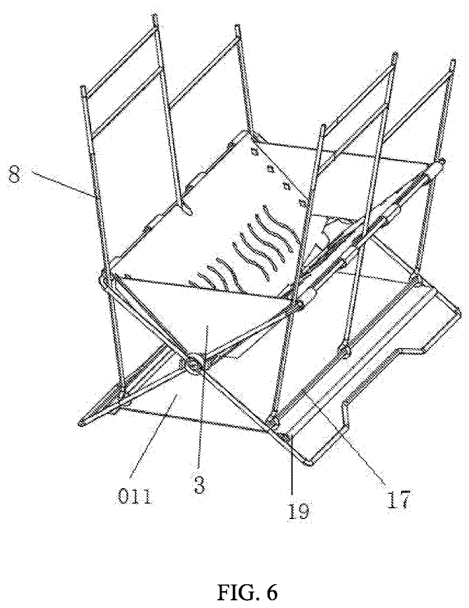

FIG. 7 is a structural schematic diagram of a barbecue grill in embodiment 6 provided by the present invention;

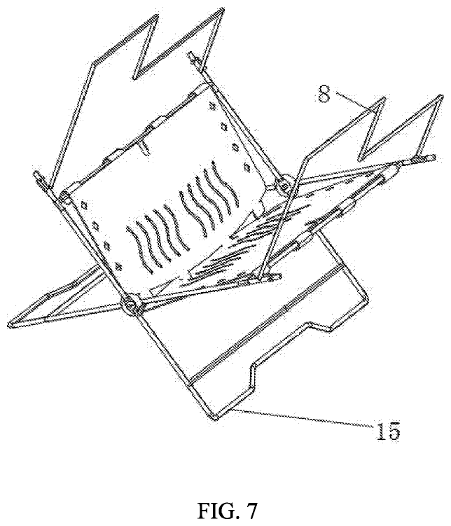

FIG. 8 is a structural schematic diagram of a barbecue grill in embodiment 7 provided by the present invention;

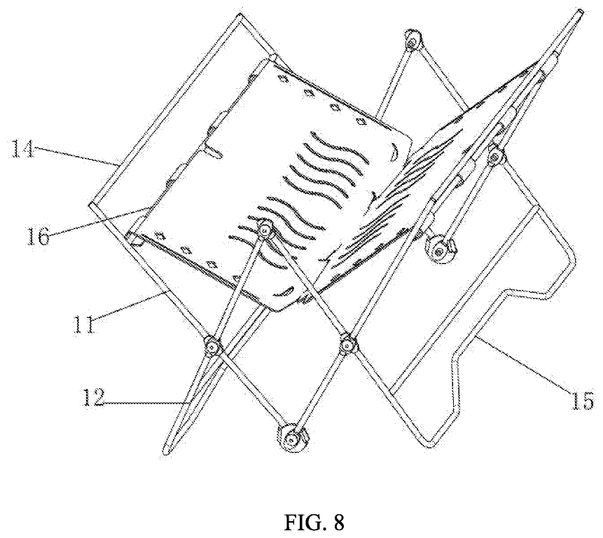

FIG. 9 is a structural schematic diagram of a barbecue grill provided with two first charcoal trays and second charcoal trays in embodiment 7 provided by the present invention;

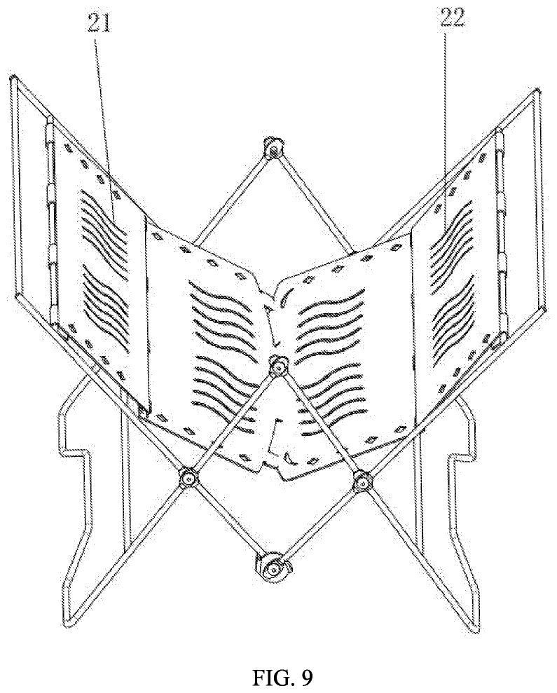

FIG. 10 is a structural schematic diagram of a barbecue grill in embodiment 8 provided by the present invention;

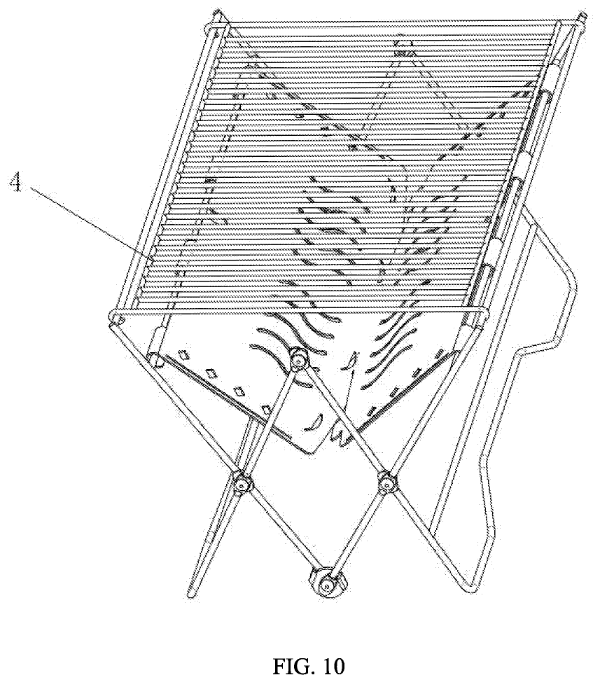

FIG. 11 is a structural schematic diagram of a barbecue grill in embodiment 9 provided by the present invention;

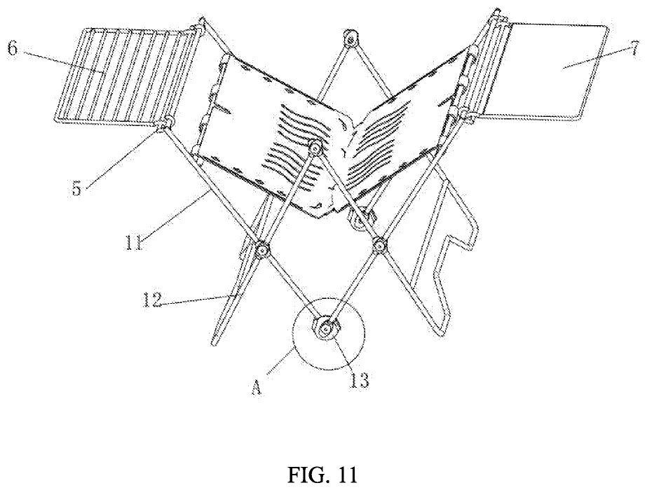

FIG. 12 is a structural schematic diagram of a barbecue grill in embodiment 10 provided by the present invention;

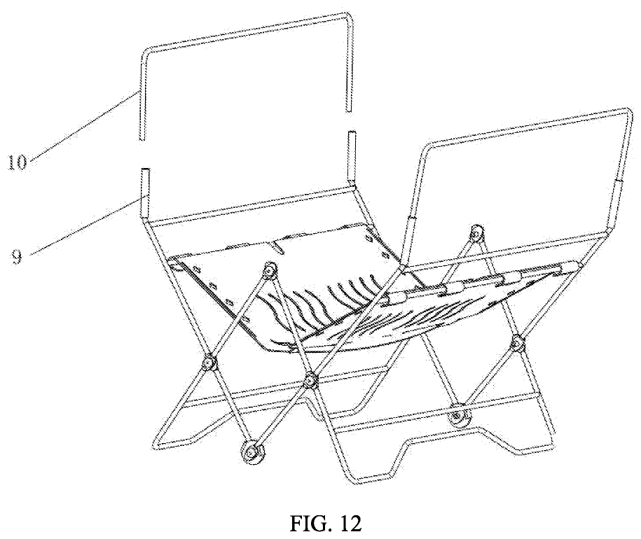

FIG. 13 is a structural schematic diagram of a barbecue grill in embodiment 11 provided by the present invention; and

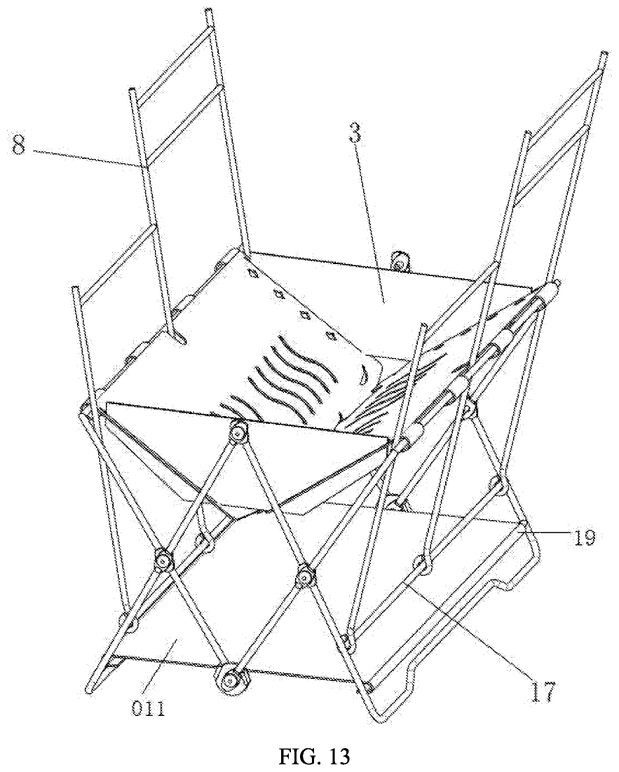

FIG. 14 is a structural enlarged view of position A in FIG. 11 provided by the present invention.

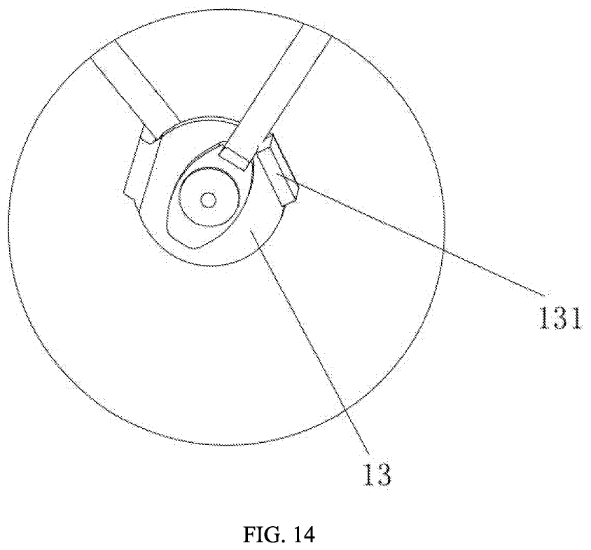

In the figures,
1—forked bracket;
11—left bracket; 12—right bracket;
13—hinging shaft structure;
131—limiting jaw;
14—top rod; 15—bottom rod; 16—transverse rod; 17—auxiliary transverse rod; 18—supporting frame; 19—auxiliary bottom rod;
2—charcoal tray;
21—first charcoal tray; 22—second charcoal tray; 23—inserting sheet; 24—inserting hole; 25—hook;
3—baffle plate; 4—barbecue net; 5—positioning frame rod; 6—grid frame; 7—stowage plate; 8—high and low double—rod frame; 9—vertical pipe; 10—extension frame; 011—ash receiving plate.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

### Embodiment 1

Embodiments of the present invention disclose a folding barbecue grill which comprises:

a forked bracket 1; and

a charcoal receiving assembly, wherein the charcoal receiving assembly is arranged on the forked bracket 1.

To further optimize the above technical solution, the charcoal receiving assembly is a charcoal tray 2 or a charcoal net or a fireproof fiber cloth.

To further optimize the above technical solution, the charcoal tray 2 is selected as the charcoal receiving assembly, and the charcoal tray is detachably arranged on the top of the forked bracket 1.

To further optimize the above technical solution, the charcoal tray 2 comprises first charcoal trays 21 and second charcoal trays 22, and the first charcoal trays 21 and the second charcoal trays 22 are respectively detachably connected to both sides of the top of the forked bracket 1; and the bottoms of the first charcoal trays 21 and the bottoms of the second charcoal trays 22 are detachably connected.

To further optimize the above technical solution, the tops of the first charcoal trays 21 and the tops of the second charcoal trays 22 are provided with hooks 25; the bottoms of the first charcoal trays 21 are uniformly provided with a plurality of inserting sheets 23; the bottoms of the second charcoal trays 22 are provided with inserting holes 24 at positions corresponding to the inserting sheets 23; and the inserting sheets 23 are correspondingly inserted into the inserting holes 24.

To further optimize the above technical solution, a plurality of first charcoal trays 21 and a plurality of second charcoal trays 22 are arranged; the plurality of first charcoal trays 21 are successively connected; the plurality of second charcoal trays 22 are successively connected; and the first charcoal tray 21 located at the bottom is connected with the second charcoal tray 22 located at the bottom. The bottom of the second charcoal tray 22 located at the top in the plurality of second charcoal trays 22 is provided with hooks 25; the top of the second charcoal tray 22 located at the middle or bottom is provided with inserting holes 24; and the plurality of second charcoal trays 22 are successively inserted, to facilitate installation and disassembly.

### Embodiment 2

To further optimize the above technical solution, the forked bracket 1 comprises: left brackets 11, right brackets 12 and a hinging shaft structure 13; the left brackets 11 and the right brackets 12 are crossed in X-shaped arrangement, and the hinging shaft structure 13 is arranged at a hinging position between the left brackets 11 and the right brackets 12; the surface of the hinging shaft structure 13 is provided with two limiting jaws 131 which are respectively placed below the left brackets 11 and the right brackets 12, and abutted against the left brackets 11 and the right brackets 12; two groups of left brackets 11 and two groups of right brackets 12 are arranged, and top rods 14 are respectively arranged between the tops of the two left brackets 11 and between the tops of the two right brackets 12; and bottom rods 15 are respectively arranged between the bottoms of the two left brackets 11 and between the bottoms of the two right brackets 12.

To further optimize the above technical solution, auxiliary bottom rods 19 are respectively arranged between the bottoms of the two left brackets 11 and between the bottoms of the two right brackets 12; the auxiliary bottom rods 19 are located above the bottom rods 15; and an ash receiving plate 011 is connected between the two auxiliary bottom rods 19.

To further optimize the above technical solution, both sides of the first charcoal trays 21 and the second charcoal trays 22 are provided with baffle plates 3. Both sides of the surfaces of the first charcoal trays 21 and the second charcoal trays 22 are provided with inserting slot holes, and both sides of the baffle plates 3 are inserted into the inserting slot holes.

Other technical solutions in the present embodiment are the same as that in embodiment 1, and will not be repeated in detail.

### Embodiment 3

To further optimize the above technical solution, transverse rods 16 are respectively arranged between the tops of the two left brackets 11 and between the tops of the two right brackets 12; the tops of the first charcoal trays 21 and the tops of the second charcoal trays 22 are respectively connected with two transverse rods 16; the tops of the left brackets 11 and the right brackets 12 are provided with a barbecue net 4; and both sides of the barbecue net 4 are detachably connected with two top rods 14 respectively.

Other technical solutions in the present embodiment are the same as that in embodiment 1, and will not be repeated in detail.

### Embodiment 4

To further optimize the above technical solution, transverse rods 16 are respectively arranged between the tops of the two left brackets 11 and between the tops of the two right brackets 12; the tops of the first charcoal trays 21 and the tops of the second charcoal trays 22 are respectively connected with two transverse rods 16; the surfaces of the two top rods 14 are provided with positioning frame rods 5; the positioning frame rods 5 are arranged on one side of the top rods 14 away from the first charcoal trays 21 or the second charcoal trays 22; one of the top rods 14 is hinged with a grid frame 6; the grid frame 6 is placed at the top of the positioning frame rods 5; the other top rod 14 is hinged with a stowage plate 7; and the stowage plate 7 is placed at the top of the positioning frame rods 5. The positioning frame rods 5 are used for supporting the bottom of the grid frame 6 or the stowage plate 7 so that the grid frame 6 and the stowage plate 7 are in a horizontal state.

Other technical solutions in the present embodiment are the same as that in embodiment 1, and will not be repeated in detail.

### Embodiment 5

To further optimize the above technical solution, the tops of the first charcoal trays 21 and the tops of the second charcoal trays 22 are respectively connected with the two top rods 14; auxiliary transverse rods 17 are respectively arranged between the bottoms of the two left brackets 11 and between the bottoms of the two right brackets 12; high and low double-rod frames 8 are hinged at the auxiliary transverse rods 17; and the tops of the high and low double-rod frames 8 extend upwards and are abutted against one side of the top rods 14 close to the first charcoal trays 21 or the second charcoal trays 22.

Other technical solutions in the present embodiment are the same as that in embodiment 1, and will not be repeated in detail.

### Embodiment 6

To further optimize the above technical solution, the tops of the first charcoal trays 21 and the tops of the second charcoal trays 22 are respectively connected with the two top rods 14; and the high and low double-rod frames 8 are respectively connected between the tops of the two left brackets 11 and between the tops of the two right brackets 12.

Other technical solutions in the present embodiment are the same as that in embodiment 1, and will not be repeated in detail.

### Embodiment 7

To further optimize the above technical solution, the forked bracket 1 comprises: first bracket groups, second bracket groups and a hinging shaft structure 13; the first bracket groups and the second bracket groups are respectively formed by crossing and hinging the left brackets 11 and the right brackets 12 in X shape; the tops of the right brackets 12 of the first bracket groups are hinged with the tops of the left brackets 11 of the second bracket groups; the hinging shaft structure 13 is arranged at a joint between the bottoms of the left brackets 11 of the first bracket groups and the bottoms of the right brackets 12 of the second bracket groups; the surface of the hinging shaft structure 13 is provided with two limiting jaws 131 which are respectively placed below the left brackets 11 and the right brackets 12, and abutted against the left brackets 11 and the right brackets 12; two first bracket groups and two second bracket groups are respectively arranged; top rods 14 are respectively arranged between the tops of the left brackets 11 of the two first bracket groups and between the tops of the right brackets 12 of the two second bracket groups; and bottom rods 15 are respectively arranged between the bottoms of the right brackets 12 of the two first bracket groups and between the bottoms of the left brackets 11 of the two second bracket groups.

To further optimize the above technical solution, auxiliary bottom rods 19 are respectively arranged between the bottoms of the right brackets 12 of the two first bracket groups and between the bottoms of the left brackets 11 of the two second bracket groups; the auxiliary bottom rods 19 are located above the bottom rods 15; and an ash receiving plate 011 is connected between the two auxiliary bottom rods 19.

To further optimize the above technical solution, both sides of the first charcoal trays 21 and the second charcoal trays 22 are provided with baffle plates 3.

Other technical solutions in the present embodiment are the same as that in embodiment 1, and will not be repeated in detail.

### Embodiment 8

To further optimize the above technical solution, transverse rods 16 are respectively arranged between the tops of the left brackets 11 of the two first bracket groups and between the tops of the right brackets 12 of the second bracket groups; the tops of the first charcoal trays 21 and the tops of the second charcoal trays 22 are respectively connected with the two transverse rods 16; the tops of the first bracket groups and the second bracket groups are provided with a barbecue net 4; and both sides of the barbecue net 4 are detachably connected with two top rods 14 respectively.

Other technical solutions in the present embodiment are the same as that in embodiment 1, and will not be repeated in detail.

### Embodiment 9

To further optimize the above technical solution, transverse rods 16 are respectively arranged between the tops of the left brackets 11 of the two first bracket groups and between the tops of the right brackets 12 of the second bracket groups; the tops of the first charcoal trays 21 and the tops of the second charcoal trays 22 are respectively connected with the two transverse rods 16; the surfaces of the two top rods 14 are provided with positioning frame rods 5; the positioning frame rods 5 are arranged on one side of the top rods 14 away from the first charcoal trays 21 or the second charcoal trays 22; one of the top rods 14 is hinged with a grid frame 6; the grid frame 6 is placed at the top of the positioning frame rods 5; the other top rod 14 is hinged with a stowage plate 7; and the stowage plate 7 is placed at the top of the positioning frame rods 5.

Other technical solutions in the present embodiment are the same as that in embodiment 1, and will not be repeated in detail.

### Embodiment 10

To further optimize the above technical solution, the tops of the first charcoal trays 21 and the tops of the second charcoal trays 22 are respectively connected with the two top rods 14; the tops of the left brackets 11 of the first bracket groups and the tops of the right brackets 12 of the two second bracket groups are provided with hollow vertical pipes 9; the tops of the top rods 14 are provided with U-shaped extension frames 10; and two U-shaped ends of the extension frames 10 are respectively inserted into the vertical pipes 9 at both ends of the top rods 14. A barbecue net can be arranged at two vertical pipes 9 so that double-layer barbecue can be conducted.

Other technical solutions in the present embodiment are the same as that in embodiment 1, and will not be repeated in detail.

### Embodiment 11

To further optimize the above technical solution, the tops of the first charcoal trays 21 and the tops of the second charcoal trays 22 are respectively connected with the two top rods 14; auxiliary transverse rods 17 are respectively arranged between the bottoms of the right brackets 12 of the two first bracket groups and between the bottoms of the left brackets 11 of the two second bracket groups; high and low double-rod frames 8 are hinged at the auxiliary transverse rods 17; and the tops of the high and low double-rod frames 8 extend upwards and are abutted against one side of the top rods 14 close to the first charcoal trays 21 or the second charcoal trays 22.

Other technical solutions in the present embodiment are the same as that in embodiment 1, and will not be repeated in detail.

Each embodiment in the description is described in a progressive way. The difference of each embodiment from each other is the focus of explanation. The same and similar parts among all of the embodiments can be referred to each other.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

What is claimed is:

1. A folding barbecue grill, comprising:
a forked bracket (1); and
a charcoal receiving assembly, wherein the charcoal receiving assembly is arranged on the forked bracket (1).

2. The folding barbecue grill according to claim 1, wherein the charcoal receiving assembly is a charcoal tray (2) or a charcoal net or a fireproof fiber cloth.

3. The folding barbecue grill according to claim 2, wherein the charcoal tray (2) is selected as the charcoal receiving assembly, and the charcoal tray is detachably arranged on the top of the forked bracket (1).

4. The folding barbecue grill according to claim 3, wherein the charcoal tray (2) comprises first charcoal trays (21) and second charcoal trays (22), and the first charcoal trays (21) and the second charcoal trays (22) are respectively detachably connected to both sides of the top of the forked bracket (1); and the bottoms of the first charcoal trays (21) and the bottoms of the second charcoal trays (22) are detachably connected.

5. The folding barbecue grill according to claim 4, wherein the tops of the first charcoal trays (21) and the tops of the second charcoal trays (22) are provided with hooks (25); the bottoms of the first charcoal trays (21) are uniformly provided with a plurality of inserting sheets (23); the bottoms of the second charcoal trays (22) are provided with inserting holes (24) at positions corresponding to the inserting sheets (23); and the inserting sheets (23) are correspondingly inserted into the inserting holes (24).

6. The folding barbecue grill according to claim 5, wherein a plurality of first charcoal trays (21) and a plurality of second charcoal trays (22) are arranged; the plurality of first charcoal trays (21) are successively connected; the plurality of second charcoal trays (22) are successively connected; and the first charcoal tray (21) located at the bottom is connected with the second charcoal tray (22) located at the bottom.

7. The folding barbecue grill according to claim 1, wherein the forked bracket (1) comprises: left brackets (11), right brackets (12) and a hinging shaft structure (13); the left brackets (11) and the right brackets (12) are crossed in X-shaped arrangement, and the hinging shaft structure (13) is arranged at a hinging position between the left brackets (11) and the right brackets (12); the surface of the hinging shaft structure (13) is provided with two limiting jaws (131) which are respectively placed below the left brackets (11) and the right brackets (12), and abutted against the left brackets (11) and the right brackets (12); two groups of left brackets (11) and two groups of right brackets (12) are arranged, and top rods (14) are respectively arranged between the tops of the two left brackets (11) and between the tops of the two right brackets (12); and bottom rods (15) are respectively arranged between the bottoms of the two left brackets (11) and between the bottoms of the two right brackets (12).

8. The folding barbecue grill according to claim 7, wherein auxiliary bottom rods (19) are respectively arranged between the bottoms of the two left brackets (11) and between the bottoms of the two right brackets (12); the auxiliary bottom rods (19) are located above the bottom rods (15); and an ash receiving plate (011) is connected between the two auxiliary bottom rods (19).

9. The folding barbecue grill according to claim 7, wherein both sides of the first charcoal trays (21) and the second charcoal trays (22) are provided with baffle plates (3).

10. The folding barbecue grill according to claim 7, wherein transverse rods (16) are respectively arranged between the tops of the two left brackets (11) and between the tops of the two right brackets (12); the tops of the first charcoal trays (21) and the tops of the second charcoal trays (22) are respectively connected with two transverse rods (16); the tops of the left brackets (11) and the right brackets (12) are provided with a barbecue net (4); and both sides of the barbecue net (4) are detachably connected with two top rods (14) respectively.

11. The folding barbecue grill according to claim 7, wherein transverse rods (16) are respectively arranged between the tops of the two left brackets (11) and between the tops of the two right brackets (12); the tops of the first charcoal trays (21) and the tops of the second charcoal trays (22) are respectively connected with two transverse rods (16); the surfaces of the two top rods (14) are provided with positioning frame rods (5); the positioning frame rods (5) are arranged on one side of the top rods (14) away from the first charcoal trays (21) or the second charcoal trays (22); one of the top rods (14) is hinged with a grid frame (6); the grid frame (6) is placed at the top of the positioning frame rods (5); the other top rod (14) is hinged with a stowage plate (7); and the stowage plate (7) is placed at the top of the positioning frame rods (5).

12. The folding barbecue grill according to claim 7, wherein the tops of the first charcoal trays (21) and the tops of the second charcoal trays (22) are respectively connected with the two top rods (14); auxiliary transverse rods (17) are respectively arranged between the bottoms of the two left brackets (11) and between the bottoms of the two right brackets (12); high and low double-rod frames (8) are hinged at the auxiliary transverse rods (17); and the tops of the high and low double-rod frames (8) extend upwards and are abutted against one side of the top rods (14) close to the first charcoal trays (21) or the second charcoal trays (22).

13. The folding barbecue grill according to claim 7, wherein the tops of the first charcoal trays (21) and the tops of the second charcoal trays (22) are respectively connected with the two top rods (14); and the high and low double-rod frames (8) are respectively connected between the tops of the two left brackets (11) and between the tops of the two right brackets (12).

14. The folding barbecue grill according to claim 1, wherein the forked bracket (1) comprises: first bracket groups, second bracket groups and a hinging shaft structure (13); the first bracket groups and the second bracket groups are respectively formed by crossing and hinging the left brackets (11) and the right brackets (12) in X shape; the tops of the right brackets (12) of the first bracket groups are hinged with the tops of the left brackets (11) of the second bracket groups; the hinging shaft structure (13) is arranged at a joint between the bottoms of the left brackets (11) of the first bracket groups and the bottoms of the right brackets (12) of the second bracket groups; the surface of the hinging shaft structure (13) is provided with two limiting jaws (131) which are respectively placed below the left brackets (11) and the right brackets (12), and abutted against the left brackets (11) and the right brackets (12); two first bracket groups and two second bracket groups are respectively arranged; top rods (14) are respectively arranged between the tops of the left brackets (11) of the two first bracket groups and between the tops of the right brackets (12) of the two second bracket groups; and bottom rods (15) are respectively arranged between the bottoms of the right brackets (12) of the two first bracket groups and between the bottoms of the left brackets (11) of the two second bracket groups.

15. The folding barbecue grill according to claim 14, wherein auxiliary bottom rods (19) are respectively arranged between the bottoms of the right brackets (12) of the two first bracket groups and between the bottoms of the left brackets (11) of the two second bracket groups; the auxiliary bottom rods (19) are located above the bottom rods (15); and an ash receiving plate (011) is connected between the two auxiliary bottom rods (19).

16. The folding barbecue grill according to claim 14, wherein both sides of the first charcoal trays (21) and the second charcoal trays (22) are provided with baffle plates (3).

17. The folding barbecue grill according to claim 14, wherein transverse rods (16) are respectively arranged between the tops of the left brackets (11) of the two first bracket groups and between the tops of the right brackets (12) of the second bracket groups; the tops of the first charcoal trays (21) and the tops of the second charcoal trays (22) are respectively connected with the two transverse rods (16); the tops of the first bracket groups and the second bracket groups are provided with a barbecue net (4); and both sides of the barbecue net (4) are detachably connected with two top rods (14) respectively.

18. The folding barbecue grill according to claim 14, wherein transverse rods (16) are respectively arranged between the tops of the left brackets (11) of the two first bracket groups and between the tops of the right brackets (12) of the second bracket groups; the tops of the first charcoal trays (21) and the tops of the second charcoal trays (22) are respectively connected with the two transverse rods (16); the surfaces of the two top rods (14) are provided with positioning frame rods (5); the positioning frame rods (5) are arranged on one side of the top rods (14) away from the first charcoal trays (21) or the second charcoal trays (22); one of the top rods (14) is hinged with a grid frame (6); the grid frame (6) is placed at the top of the positioning frame rods (5); the other top rod (14) is hinged with a stowage plate (7); and the stowage plate (7) is placed at the top of the positioning frame rods (5).

19. The folding barbecue grill according to claim 14, wherein the tops of the first charcoal trays (21) and the tops of the second charcoal trays (22) are respectively connected with the two top rods (14); the tops of the left brackets (11) of the first bracket groups and the tops of the right brackets (12) of the two second bracket groups are provided with hollow vertical pipes (9); the tops of the top rods (14) are provided with U-shaped extension frames (10); and two U-shaped ends of the extension frames (10) are respectively inserted into the vertical pipes (9) at both ends of the top rods (14).

20. The folding barbecue grill according to claim 15, wherein the tops of the first charcoal trays (21) and the tops of the second charcoal trays (22) are respectively connected with the two top rods (14); auxiliary transverse rods (17) are respectively arranged between the bottoms of the right brackets (12) of the two first bracket groups and between the bottoms of the left brackets (11) of the two second bracket groups; high and low double-rod frames (8) are hinged at the auxiliary transverse rods (17); and the tops of the high and low double-rod frames (8) extend upwards and are abutted against one side of the top rods (14) close to the first charcoal trays (21) or the second charcoal trays (22).
